(19) United States
(12) Patent Application Publication
(10) Pub. No.: US 2011/0223930 A1
(43) Pub. Date: Sep. 15, 2011

(54) SYSTEM AND METHOD FOR MONITORING SIGNAL QUALITY

(76) Inventor: Marc A. Todd, Foxboro, MA (US)

(21) Appl. No.: 12/721,934

(22) Filed: Mar. 11, 2010

(51) Int. Cl. H04W 64/00

(52) U.S. Cl. 455/456.1

(57) ABSTRACT

Position data indicative of a geographic location of a mobile device is repetitively received. Additionally, signal quality data indicative of a wireless signal quality at the mobile device is also repetitively received. Mobile device data is generated based upon, at least in part, at least a portion of the position data and at least a portion of the signal quality data.

### TECHNICAL FIELD

The present disclosure generally relates to mobile devices, and more particularly to the monitoring of signal quality.

### BACKGROUND

In an information-based society, the rate at which information is received and disseminated may prove crucial with respect to the value of that information. The value of this information may be even more greatly impacted in sectors in which the decisions being made that are associated with the information are highly dependent upon the ability draw associations between different types of information.

### SUMMARY OF THE DISCLOSURE

According to one implementation, a computer implemented method includes repetitively receiving, by a computing system, position data indicative of a geographic location of a mobile device. Signal quality data indicative of a wireless signal quality at the mobile device is also repetitively received by the computing system. Mobile device data is generated based upon, at least in part, at least a portion of the position data and at least a portion of the signal quality data.

One or more of the following features may be included. Repetitively receiving position data may include receiving position data at predetermined intervals. Repetitively receiving position data may include receiving position data in response to, at least in part, a change in the geographic location of the mobile device. Repetitively receiving signal quality data may include receiving signal quality data at predetermined intervals. Repetitively receiving signal quality data may include receiving signal quality data in response to, at least in part, a change in signal quality at the mobile device.

The signal quality data may be based upon, at least in part, signal strength at the mobile device. The signal quality data may be based upon, at least in part, an available bandwidth at the mobile device. The signal quality data may include at least a portion of a screen shot of the mobile device.

The method may further include correlating the mobile device data with one or more additional sets of data. The one or more additional sets of data may include one or more of position data and signal quality data associated with at least a second mobile device. The one or more additional sets of data may include geographically relevant data. The one or more additional sets of data may include temporally relevant data.

According to another implementation, a computer program product resides on a computer readable medium having a plurality of instructions stored on it. When executed by a processor, the instructions cause the processor to perform operations including repetitively receiving, by a computing system, position data indicative of a geographic location of a mobile device. The instruction also cause the processor to repetitively receive, by the computing system, signal quality data indicative of a wireless signal quality at the mobile device. Additionally, the instructions may cause the processor to generate mobile device data based upon, at least in part, at least a portion of the position data and at least a portion of the signal quality data.

One or more of the following features may be included. The instructions for repetitively receiving position data may include instructions for receiving position data at predetermined intervals. The instructions for repetitively receiving position data may include instructions for receiving position data in response to, at least in part, a change in the geographic location of the mobile device. The instructions for repetitively receiving signal quality data may include instructions for receiving signal quality data at predetermined intervals. The instructions for repetitively receiving signal quality data may include instructions for receiving signal quality data in response to, at least in part, a change in signal quality at the mobile device.

The signal quality data may be based upon, at least in part, signal strength at the mobile device. The signal quality data may be based upon, at least in part, an available bandwidth at the mobile device. The signal quality data may include at least a portion of a screen shot of the mobile device.

The computer program product may include instructions for correlating the mobile device data with one or more additional sets of data. The one or more additional sets of data may include one or more of position data and signal quality data associated with at least a second mobile device. The one or more additional sets of data may include geographically relevant data. The one or more additional sets of data may include temporally relevant data.

According to yet another implementation, a system includes a processor and a memory. A first software module is executable by the processor and the memory. The first software module is configured to repetitively receive position data indicative of a geographic location of a mobile device. A second software module is also executable by the processor and the memory. The second software module is configured to repetitively receive signal quality data indicative of a wireless signal quality at the mobile device. A third software module is also executable by the processor and the memory. The third software module is configured to generate mobile device data based upon, at least in part, at least a portion of the position data and at least a portion of the signal quality data.

One or more of the following features may be included. The first software module, configured to repetitively receive position data may be configured to receive position data at predetermined intervals. The first software module, configured to repetitively receive position data, may be configured to receive position data in response to, at least in part, a change in the geographic location of the mobile device. The second software module, configured to repetitively receive signal quality data, may be configured to receive signal quality data at predetermined intervals. The second software module, configured to repetitively receive signal quality data, may be configured to receive signal quality data in response to, at least in part, a change in signal quality at the mobile device.

The signal quality data may be based upon, at least in part, signal strength at the mobile device. The signal quality data may be based upon, at least in part, an available bandwidth at the mobile device. The signal quality data may include at least a portion of a screen shot of the mobile device.

The system may also include a fourth software module, executable by the processor and the memory. The fourth software module may be configured to correlate the mobile device data with one or more additional sets of data. The one or more additional sets of data may include one or more of position data and signal quality data associated with at least a second mobile device. The one or more additional sets of data may include geographically relevant data. The one or more additional sets of data may include temporally relevant data.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a signal monitoring process coupled to a distributed computing network.

FIG. 2. is a flowchart of a process executed by the signal monitoring process of FIG. 1.

FIG. 3 diagrammatically depicts a display of a mobile device of FIG. 1.

FIG. 4 is a diagrammatic view of a webpage displaying correlated data generated by the signal monitoring process of FIG. 1.

### DETAILED DESCRIPTION OF EXEMPLARY EMBODIMENTS

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable (i.e., computer-usable) medium(s) having computer-usable program code embodied thereon.

Any combination of one or more computer-readable medium(s) may be utilized. The computer-readable medium include a computer-readable storage medium, which may be, for example, but is not limited to, an electronic, magnetic, optical, electromagnetic, infrared, or semiconductor system, apparatus, a device, or any suitable combination of the foregoing. Exemplary computer readable storage medium may include, but is not limited to, a portable computer diskette, a hard disk, a solid state disc drive, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any medium that can contain, or store a program for use by or in connection with an instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on a single computing device, e.g., as a stand-alone software package, and or may be at least partly executed on multiple computing devices that may be remote to one another. In the latter scenario, remote computing devices may be connected to one another through a local area network (LAN) or a wide area network (WAN), or the connection may be made to one or more remote computing devices (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

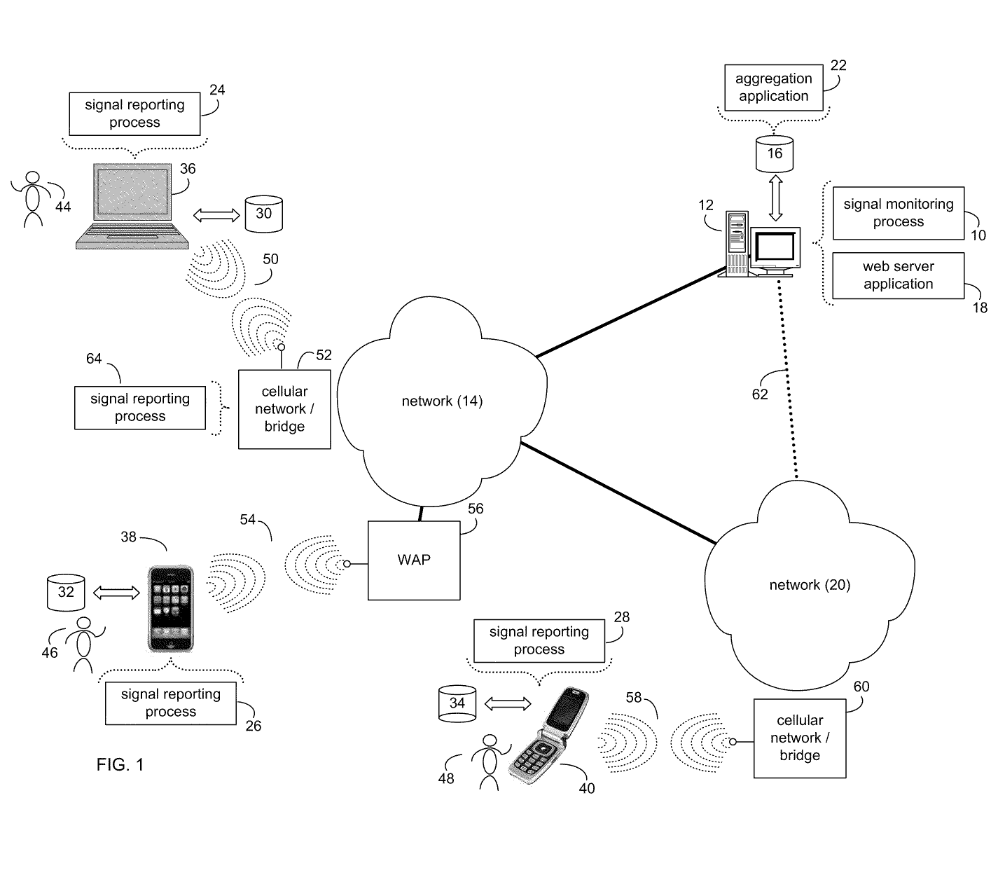

Referring to FIG. 1, there is shown signal monitoring process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® XP Server; Novell® NetWare®; or Red Hat® Linux®, for example (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both), for example.

As will be discussed below in greater detail, signal monitoring process 10 may repetitively receive position data indicative of a geographic location of a mobile device. Signal monitoring process 10 may also repetitively receive signal quality data indicative of a wireless signal quality at the mobile device. Signal monitoring process 10 may generate mobile device data based upon, at least in part, at least a portion of the position data and at least a portion of the signal quality data.

The instruction sets and subroutines of signal monitoring process 10, which may include one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive, a tape drive; an optical drive; a RAID array; a random access memory (RAM); and a read-only memory (ROM).

Server computer 12 may execute web server application 18, examples of which may include but are not limited to: Microsoft IIS, Novell Webserver™, or Apache® Webserver, that allows for HTTP (i.e., HyperText Transfer Protocol) access to server computer 12 via network 14 (Webserver is a trademark of Novell Corporation in the United States, other countries, or both; and Apache is a registered trademark of Apache Software Foundation in the United States, other countries, or both), hosting of one or more web pages and/or web sites, and the like. Network 14 may be connected to one or more secondary networks (e.g., network 20), examples of which may include but are not limited to: a local area network; a wide area network; or an intranet, for example.

Signal monitoring process 10 (alone, or in combination with one or more of web server application 18 and aggregation application 22) may generate mobile device data based upon, at least in part, at least a portion of the repetitively received position data and at least a portion of the repetitively received signal quality data. At least a portion of the position data and/or at least a portion of the signal quality data may be repetitively received from one or more signal reporting processes (e.g., signal reporting processes 24, 26, 28), which may repetitively transmit at least a portion of the position data and/or may repetitively transmit at least a portion of the signal quality data associated with a respective mobile device. Aggregation application 22 may include a data storage and management application, for example, but not limited to, a database application such as SQL Server™, MySQL™, and Oracle™ database applications. Additionally, signal monitoring process 10 (alone, or in combination with one or more of web server application 18 and aggregation application 22) may correlate the mobile device data with one or more additional sets of data. Signal monitoring process 10 may be a standalone application. Additionally/alternatively, signal monitoring process 10 may interact with web server application 18 and/or may be incorporated into web server application 18 as a module or component of web server application.

The instruction sets and subroutines of signal reporting processes 24, 26, 28, (which may include one or more software modules) which may be stored on storage devices 30, 32, 34 (respectively) coupled to mobile devices 36, 38, 40 (respectively), may be executed by one or more processors (not shown) and one or more memory modules (not shown) incorporated into mobile devices 36, 38, 40 (respectively). Storage devices 30, 32, 34 may include but are not limited to: hard disk drives; solid state drives, tape drives; optical drives; RAID arrays; random access memories (RAM); read-only memories (ROM), compact flash (CF) storage devices, secure digital (SD) storage devices, and a memory stick storage devices. Examples of mobile devices 36, 38, 40 may include, but are not limited to, laptop computer 36 (e.g., which may include a cellular modem), smart phone 38, and cellular telephone 40. Mobile devices 36, 38, 40 may be capable of being connected to a data network (e.g., network 14, network 20) via various wireless communication channels (e.g., WiFi communication channel, Bluetooth communication channel, cellular communication channel, or the like). Using mobile devices 36, 38, 40 users 44, 46, 48 receive and transmit data and/or voice calls.

The various mobile devices may be capable of being directly or indirectly coupled to network 14 (or network 20). For example, laptop computer 36 is shown coupled to network 14 via wireless communication channel 50 established between laptop computer 36 and cellular network/bridge 52. Similarly, a smart phone 38 may be wirelessly coupled to network 14 (or network 20) via wireless communication channel 54 established between smart phone 38 and wireless access point 56 (i.e., WAP), which may be coupled to network 14. WAP 56 may be, for example, an IEEE 802.11a, 802.11b, 802.11g, Wi-Fi, and/or Bluetooth device that is capable of establishing the wireless communication channel between the laptop computer and the WAP. Cellular telephone 40 is shown wirelessly coupled to network 14 via wireless communication channel 58 established between cellular telephone 40 and cellular network/bridge 60, which is shown directly coupled to network 20.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Mobile devices 36, 38, 40 may each execute an operating system, examples of which may include but are not limited to Microsoft Windows, Microsoft Windows CE®, Red Hat Linux, etc., or a custom operating system (Windows CE is a registered trademark of Microsoft Corporation in the United States, other countries, or both).

For the purpose of the following description, mobile device 36 will generally be discussed. However, this should not be construed as a limitation of the present disclosure, as other mobile devices (e.g., mobile devices 38, 40) may be equally utilized.

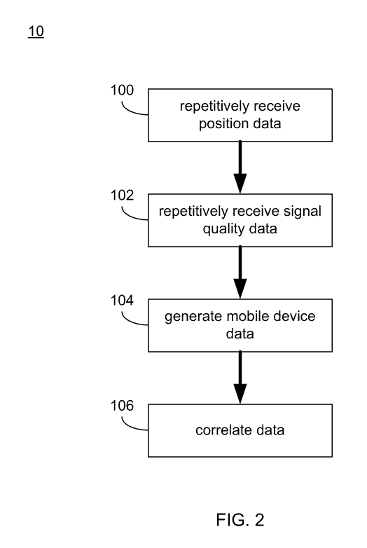

Referring also to FIG. 2, signal monitoring process 10 may generally repetitively receive 100 position data indicative of a geographic location of a mobile device. Additionally, signal monitoring process 10 may repetitively receive 102 signal quality data indicative of a signal quality at the mobile device. Further, signal monitoring process 10 may generate mobile device data based upon, at least in part, at least a portion of the position data and at least a portion of the signal quality data.

For example, user 44 may have mobile device 36 on his person, and may be standing at the corner of St. James Avenue and Arlington St. in Boston, Mass. Signal monitoring process 10 may repetitively receive 100 position data indicative of the geographic location (e.g., the corning of St. James Avenue and Arlington St.) of mobile device 36. The position data indicative of the geographic location of mobile device 36 may be based upon, for example, location coordinates determined via a global positioning system (GPS) included within mobile device 36, via triangulation (or similar location technique) utilizing wireless signals (e.g., cellular communication channel), or the like. Signal reporting process 24 may repetitively transmit position data indicative of the geographic location of mobile device 36. Signal monitoring process 10 may repetitively receive 100 the position information repetitively transmitted by signal reporting process 24.

Additionally/alternatively, the geographic location of mobile device 36 may be determined by a device other than mobile device 36. For example, the geographic location of mobile device 36 may be determined by a cellular network/transmission system. For example, the general geographic location of mobile device 36 may be determined based upon, at least in part, a detected proximity to cellular network/bridge 52, via triangulation utilizing more than one cellular network/bridge, or other similar technique. In such an example, a signal reporting process associated with a wireless communication system (e.g., signal reporting process 64 executing on cellular network/bridge 52) may repetitively transmit position data indicative of the geographic location of mobile device 36. In such an embodiment, signal monitoring process may repetitively receive 100 position data indicative of a geographic location of mobile device 36 transmitted by signal reporting process 64.

The level of granularity of the geographic location of the mobile device may vary depending upon system attributes, design criteria, and the like. For example, the position data indicative of the geographic location of mobile device 36 may include GPS determined coordinates, which may be accurate to within a couple of meters. Additionally/alternatively, the position data indicative of the geographic location of mobile device 36 may be a general geographic location (e.g., the position data may indicate that mobile device 30 is within a three mile radius of cellular network/bridge 52). Further, the level of granularity of geographic location provided by the position data may vary depending upon the resources (e.g., general proximity, triangulation, GPS receiver, etc.) available for determining the geographic location of the mobile device.

Repetitively receiving 100 position data may include receiving position data at predetermined intervals. For example, signal monitoring process 10 may receive 100 position data indicative of the geographic location of mobile device 36 at regular time intervals, e.g., signal monitoring process 10 may receive 100 position data indicative of the geographic location of mobile device at one minute time intervals, thereby repetitively receiving 100 position data for mobile device 36 every minute. While the example of one minute time intervals has been discussed, this should not be construed as a limitation of the present disclosure as other time intervals (either regular or irregular) may be equally utilized depending upon design criteria and user preference. In one example, signal reporting process 24 (and/or, e.g., signal reporting process 64, etc.), executing on mobile device 36, may transmit position data at one minute intervals, and, as such, signal monitoring process 10 may repetitively receive 100 position data for mobile device 36 at one minute intervals.

Additionally/alternatively, repetitively receiving 100 position data may include receiving position data in response to, at least in part, a change in the geographic location of the mobile device. For example, and continuing with the above-described situation in which mobile device 36 is located at the corner of St. James Avenue and Arlington St. in Boston, Mass., user 44 (along with mobile device 36) may move to the corner of St. James Avenue and Dartmouth St. In response to the change in geographic location of mobile device 36, signal monitoring process 10 may receive 100 position data for mobile device 36. For example, signal reporting process 24 (and/or, e.g., signal reporting process 64, etc.) may transmit a position data in response to the change in geographic location of mobile device 36. Signal monitoring process 10 (having previously received position data for mobile device 36 indicative of a geographic location of mobile device 36 at the corner of St. James Avenue and Arlington St.) may receive 100 position data for mobile device 36 indicative of a geographic location at the corner of St. James Avenue and Dartmouth St., thereby repetitively receiving 100 position data indicative of a geographic location of mobile device 36. The magnitude of the change in geographic location giving rise to signal monitoring process 10 receiving 100 position data for mobile device 36 may vary depending upon design criteria, granularity of location detection (e.g., varying depending upon the resources utilized for determining the geographic location of mobile device 36), and the like.

Further, repetitively receiving 100 position data for mobile device 36 may include receiving 100 position data for mobile device 36 based upon, at least in part, the occurrence of an event. The event may include, for example, a usage event (e.g., voice call, data transmission/reception, etc.). In one particular example, the usage event may include rendering video content (e.g., which may include streaming video content received via wireless communication channel 50) on mobile device 36. In such an example, signal receiving process 10 may receive 100 position data for mobile device 36 when video rendering on mobile device 36 begins. Similarly, signal receiving process 10 may receive 100 position data for mobile device 36 when video rendering on mobile device 36 ends. Still further, signal receiving process 10 may receive 100 position data for mobile device 36 at one or more time periods while video content is being rendered on mobile device 36.

Similar to repetitively receiving 100 position data indicative of a geographic location of mobile device 36, repetitively receiving 102 signal quality data may include receiving signal quality data at predetermined intervals. For example, signal monitoring process 10 may receive 102 signal quality data indicative of a signal quality at mobile device 36 at regular time intervals, e.g., signal monitoring process 10 may receive 102 signal quality data indicative of a signal quality at mobile device 36 at one minute time intervals, thereby repetitively receiving 102 signal quality data at mobile device 36 every minute. While the example of one minute time intervals has been discussed, this should not be construed as a limitation of the present disclosure as other time intervals (either regular or irregular) may be equally utilized depending upon design criteria and user preference. In one example, signal reporting process 24 (and/or, e.g., signal reporting process 64, etc.), executing on mobile device 36, may transmit signal quality data at one minute intervals, and, as such, signal monitoring process 10 may repetitively receive 102 signal quality data for mobile device 36 at one minute intervals.

Additionally/alternatively, repetitively receiving 102 signal quality data may include receiving signal quality data in response to, at least in part, a change in signal quality at the mobile device. For example, signal quality at mobile device 36 may initially be high at a first time. Signal monitoring process 10 may receive 102 signal quality data indicating a high signal quality at the first time. Subsequently, the signal quality at mobile device 36 may change (e.g., the signal quality may be relatively lower at a second time). In response to, at least in part, the change (i.e., decrease in signal quality in the above-example) in signal quality, signal monitoring process 10 may receive 102 signal quality data indicating a relatively lower signal quality at the second time. As such, signal monitoring process 10 may repetitively receive 102 signal quality data indicative of a signal quality at mobile device 36.

Further, repetitively receiving 102 signal quality data may include receiving 102 signal quality data based upon, at least in part, the occurrence of an event. The event may include, for example, a usage event (e.g., voice call, data transmission/reception, etc.). In one particular example, the usage event may include rendering video content (e.g., which may include streaming video content received via wireless communication channel 50) on mobile device 36. In such an example, signal receiving process 10 may receive 102 signal quality data for mobile device 36 when video rendering on mobile device 36 begins. Similarly, signal receiving process 10 may receive 102 signal quality data for mobile device 36 when video rendering on mobile device 36 ends. Still further, signal receiving process 10 may receive 102 signal quality data for mobile device 36 at one or more time periods while video content is being rendered on mobile device 36.

The signal quality at a mobile device may be determined in a variety of manners. For example, the signal quality data may be based upon, at least in part, signal strength at the mobile device. Signal strength at mobile device 36 may be determined utilizing signal strength measuring circuitry included within mobile device 36. According to an embodiment, signal reporting process 24 may transmit signal quality data indicative of the measured signal strength at mobile device 36. The measured signal strength at mobile device 36 may include the signal power at mobile device 36. The transmitted signal quality data may be received 102 by signal monitoring process 10.

Additionally/alternatively, signal strength at mobile device 36 may be inferred, e.g., based upon, at least in part, a transmitted and/or received signal strength at cellular network/bridge 52 and a geographic location of mobile device 36 relative to cellular network/bridge 52. Additionally, in inferring the signal strength at mobile device 36 geographic features (e.g., mountains, buildings, and the like) disposed between mobile device 36 and cellular network/bridge 52 may be considered. Additionally/alternatively, the signal quality data may be based upon, at least in part, an available bandwidth at the mobile device. The available bandwidth at the mobile device may be determined, e.g., by measuring available bandwidth for data communication either at the mobile device (e.g., mobile device 36) or at the cellular network/bridge (e.g., cellular network/bridge 52), in a generally conventional manner known to those having skill in the art. Still further, the signal quality data may be based upon, at least in part, the signal type (e.g., EDGE, 3G, LTE, etc.).

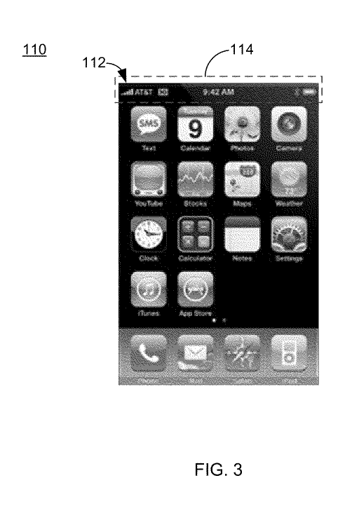

According to one particular embodiment the signal quality data may be based upon, at least in part, a screen shot (e.g., an image of and/or representing the content displayed on a screen of a mobile device), and/or a portion of a screen shot, of a display of a mobile device. For example, and referring also to FIG. 3, signal reporting process 26 (executed on mobile device 38) may take a screen shot of display 110 rendered on mobile device 38. Display 110 may included information indicative of a signal strength (e.g., signal meter 112, signal type, such as 3G, WiFi, EDGE, etc.; not shown) at mobile device 38. Signal reporting process 26 may transmit at least a portion of the screen shot of display 110. The transmitted at least a portion of the screen shot of display 110 may be received 102 by signal monitoring process 10. The at least a portion of the screen shot of display 110 may optionally include only a portion of display 110. For example, the screen shot may only include status bar portion 114 and/or may only include a portion of display 110 including signal meter 112. Accordingly, the size of the transmitted data may be reduced (e.g., due at least in part to the relatively smaller image size). Further, the screen shot may include a black and white image, which may further allow the transmitted data to be reduced. The image, in some embodiments, may be compressed and/or may be a relatively low resolution image (e.g., but which may still allow the displayed signal strength, i.e., the number of signal bars, to be discernable), which may also allow the transmitted data to be reduced.

Position data indicative of a geographic location of the mobile device and signal quality data indicative of a signal quality at the mobile device may be received 100, 102 as a single message. For example, in the exemplary embodiment in which signal reporting process 24 may transmit position data for mobile device 36, and may also transmit signal quality data for mobile device 36, the position data and the signal quality data may be sent as a single message. Accordingly, it may be possible for signal monitoring process 10 to receive 100 position data and receive 102 signal quality data for mobile device 36 as a single message (e.g., from signal reporting process 24). However, while such and embodiment is contemplated, this should not be construed as a limitation of the present disclosure as various alternatives may be equally utilized. For example, the position data and the signal quality data may each be received 100, 102 as separate messages, and need not, necessarily, be received 100, 102 as paired data (e.g., signal quality data may be received 102 without also receiving 100 position data). For example, position data may be repetitively received 100 in response to, at least in part, a change in geographic location of mobile device 36, and signal quality data may be repetitively received 102 in response to, at least in part, a change in signal quality. Accordingly, signal quality at mobile device 36 may change, while the geographic location of mobile device 36 may remain the same. Accordingly, signal monitoring process 10 may only receive 102 signal quality data for mobile device 36 (e.g., which may be transmitted by signal reporting process 24, 64, etc.). Various additional configurations and variations will be understood.

Signal monitoring process 10 may generate 104 mobile data based upon, at least in part, at least a portion of the position data and at least a portion of the signal quality data. The mobile position data generated 104 by signal monitoring process 10 may provide an indication of a signal quality at a mobile device (e.g., mobile device 36 in the examples herein-above) at various geographic locations. Additionally, the time at which each piece of position data and/or each piece of signal quality data was received 100, 102 may be included within the generated 104 mobile data.

Signal monitoring process 10 (alone and/or in combination with one or more of web server application and aggregation application 22) may correlate 106 the mobile device data with one or more additional sets of data. In one embodiment, the one or more additional sets of data may include one or more of position data and signal quality data associated with at least a second mobile device (e.g., mobile device 38). The position data and/or signal quality data of mobile device 38 may be repetitively received 100, 102 in a manner as generally described above with respect to mobile device 36.

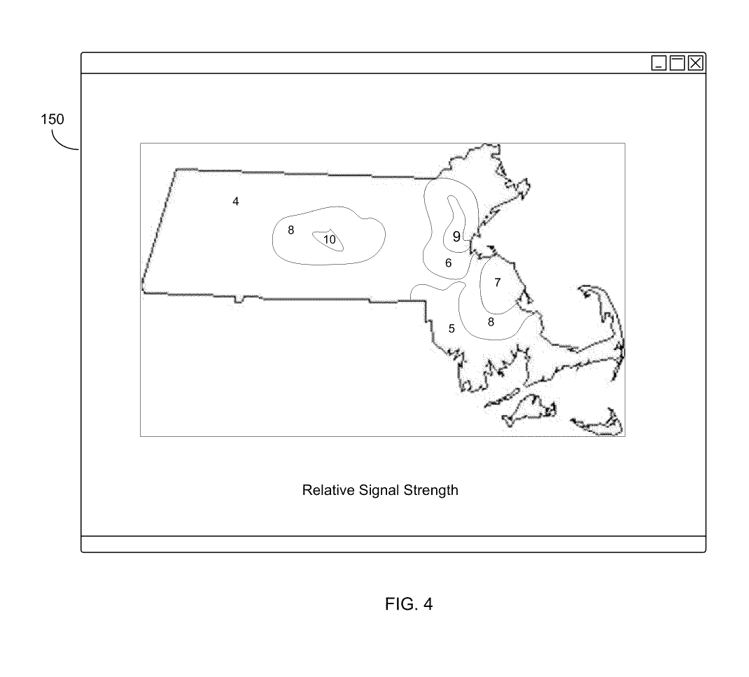

Further, the one or more additional sets of data may include geographically relevant data, and/or the one or more additional sets of data may include temporally relevant data. For example, and referring also to FIG. 4, position data and signal quality data of multiple mobile devices may be correlated and superimposed on a map, e.g., which may be included in webpage 150 (or other suitable user interface or graphical display, etc.). The superimposed data may, for example, provide a map indicating relative signal strength for various geographical areas. Similarly, a temporal component may also be included (not shown), in which changes in signal quality over time (e.g., indicating differences in signal quality for common geographic areas at a first time and a second) may be indicated.

The mobile data generated 104 by signal monitoring process 10 for one or more mobile devices may be correlated to various additional/alternative types of additional data. For example, the mobile data may be correlated to weather information, e.g., thereby indicating any relationship between signal quality and weather conditions. Various additional examples of additional types of data with which the mobile data may be correlated may include, but are not limited to, traffic patterns, population density, data usage, etc.

A number of implementations have been described. Nevertheless, it will be understood that various modifications may be made. Accordingly, other implementations are within the scope of the following claims.

What is claimed is:

1. A computer implemented method comprising:
repetitively receiving, by a computing system, position data indicative of a geographic location of a mobile device;
repetitively receiving, by the computing system, signal quality data indicative of a wireless signal quality at the mobile device; and
generating mobile device data based upon, at least in part, at least a portion of the position data and at least a portion of the signal quality data.

2. The computer implemented method of claim 1, wherein repetitively receiving position data includes receiving position data at predetermined intervals.

3. The computer implemented method of claim 1, wherein repetitively receiving position data includes receiving position data in response to, at least in part, a change in the geographic location of the mobile device.

4. The computer implemented method of claim 1, wherein repetitively receiving signal quality data includes receiving signal quality data at predetermined intervals.

5. The computer implemented method of claim 1, wherein repetitively receiving signal quality data includes receiving signal quality data in response to, at least in part, a change in signal quality at the mobile device.

6. The computer implemented method of claim 1, wherein the signal quality data is based upon, at least in part, signal strength at the mobile device.

7. The computer implemented method of claim 1, wherein the signal quality data is based upon, at least in part, an available bandwidth at the mobile device.

8. The computer implemented method of claim 1, further comprising correlating the mobile device data with one or more additional sets of data.

9. The computer implemented method of claim 8, wherein the one or more additional sets of data includes one or more of position data and signal quality data associated with at least a second mobile device.

10. The computer implemented method of claim 8, wherein the one or more additional sets of data includes geographically relevant data.

11. The computer implemented method of claim 8, wherein the one or more additional sets of data includes temporally relevant data.

12. The computer implemented method of claim 1, wherein the signal quality data includes at least a portion of a screen shot of the mobile device.

13. A computer program product residing on a computer readable medium having a plurality of instructions stored thereon, which, when executed by a processor, cause the processor to perform operations comprising:
repetitively receiving, by a computing system, position data indicative of a geographic location of a mobile device;
repetitively receiving, by the computing system, signal quality data indicative of a wireless signal quality at the mobile device; and
generating mobile device data based upon, at least in part, at least a portion of the position data and at least a portion of the signal quality data.

14. The computer program product of claim 13, wherein the instructions for repetitively receiving position data include instructions for receiving position data at predetermined intervals.

15. The computer program product of claim 13, wherein the instructions for repetitively receiving position data include instructions for receiving position data in response to, at least in part, a change in the geographic location of the mobile device.

16. The computer program product of claim 13, wherein the instructions for repetitively receiving signal quality data include instructions for receiving signal quality data at predetermined intervals.

17. The computer program product of claim 13, wherein the instructions for repetitively receiving signal quality data include instructions for receiving signal quality data in response to, at least in part, a change in signal quality at the mobile device.

18. The computer program product of claim 13, wherein the signal quality data is based upon, at least in part, signal strength at the mobile device.

19. The computer program product of claim 13, wherein the signal quality data is based upon, at least in part, an available bandwidth at the mobile device.

20. The computer program product of claim 13, further comprising instructions for correlating the mobile device data with one or more additional sets of data.

21. The computer program product of claim 20, wherein the one or more additional sets of data includes one or more of position data and signal quality data associated with at least a second mobile device.

22. The computer program product of claim 20, wherein the one or more additional sets of data includes geographically relevant data.

23. The computer program product of claim 20, wherein the one or more additional sets of data includes temporally relevant data.

24. The computer program product of claim 13, wherein the signal quality data includes at least a portion of a screen shot of the mobile device.

25. A system comprising:
a processor;
a memory;
a first software module, executable by the processor and the memory, the first software module configured to repetitively receive position data indicative of a geographic location of a mobile device;
a second software module, executable by the processor and the memory, the second software module configured to repetitively receive signal quality data indicative of a wireless signal quality at the mobile device; and
a third software module, executable by the processor and the memory, the third software module configured to generate mobile device data based upon, at least in part, at least a portion of the position data and at least a portion of the signal quality data.

26. The system of claim 25, wherein first software module, configured to repetitively receive position data is configured to receive position data at predetermined intervals.

27. The system of claim 25, wherein the first software module, configured to repetitively receive position data, is configured to receive position data in response to, at least in part, a change in the geographic location of the mobile device.

28. The system of claim 25, wherein the second software module, configured to repetitively receive signal quality data, is configured to receive signal quality data at predetermined intervals.

29. The system of claim 25, wherein the second software module, configured to repetitively receive signal quality data, is configured to receive signal quality data in response to, at least in part, a change in signal quality at the mobile device.

30. The system of claim 25, wherein the signal quality data is based upon, at least in part, signal strength at the mobile device.

31. The system of claim 25, wherein the signal quality data is based upon, at least in part, an available bandwidth at the mobile device.

32. The system of claim 25, further comprising a fourth software module, executable by the processor and the memory, the fourth software module configured to correlate the mobile device data with one or more additional sets of data.

33. The system of claim 32, wherein the one or more additional sets of data includes one or more of position data and signal quality data associated with at least a second mobile device.

34. The system of claim 32, wherein the one or more additional sets of data includes geographically relevant data.

35. The system of claim 32, wherein the one or more additional sets of data includes temporally relevant data.

36. The system of claim 25, wherein the signal quality data includes at least a portion of a screen shot of the mobile device.
